(19) United States
(12) Patent Application Publication
(10) Pub. No.: US 2016/0016255 A1
(43) Pub. Date: Jan. 21, 2016

(54) LASER CORRECTION OF METAL DEFORMATION

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/333,556

(22) Filed: Jul. 17, 2014

(51) Int. Cl. B23K 26/00; B23P 6/00; B23K 26/34

(52) U.S. Cl. CPC B23K 26/0069; B23K 26/345; B23P 6/00; B33Y 10/00

(57) ABSTRACT

Apparatus (20A-C) and a method for determining and correcting a deformation in an article (44). An energy beam (29) such as a laser beam is directed to an area (42A-C) to reverse (46, 72, 74) an existing deformation or to control deformation during additive fabrication (86, 88). Two sectionally curved areas of a deformation (50A/50C, 52/54) may be heated simultaneously to flatten a bulge between them. An existing or developing deformation may be determined by surface scanning (40) and/or a deformation may be determined predictively to pro-actively correct and prevent it while building or rebuilding a portion of the article by additive fabrication.

### FIELD OF THE INVENTION

The present invention relates to apparatus and processes for correcting deformations in metal components by selective heating with an energy beam such as a laser beam, and particularly to correction of deformations in gas turbine components.

### BACKGROUND OF THE INVENTION

Manufacturing or repair of parts often requires heating the parts. This can result in strain and distortion of the part. For example, welded fabrications are subject to distortion resulting from shrinkage strains during weld metal solidification. In some alloys, micro-structural transformations in the heat affected zone strain the material and contribute to distortion. Other distortions result from service. Residual fabrication stresses can be relieved by elevated temperature operation, resulting in geometric changes in the part. Also, creep can occur from steady state or cyclic stresses experienced by parts over time at elevated temperatures. Manufacturing distortions can be reduced by methods such as strong fixturing, low heat welding, back stepping of weld progression, and chill blocks to minimize heat input to the substrate. Distortion can be partly corrected by plastically bending the component by force. However such restoration is imprecise, can strain harden (cold work) the part, can introduce additional stresses, and can damage the part, especially if it is in a weakened or crack prone condition.

Heat straightening is another method to correct distortion. A weld between two straight lengths of pipe may result in a bend at the weld. Re-melting the weld on the obtuse side of the bend can introduce weld shrinkage to promote straightening. This is used to straighten fuel injection rockets in combustion support housings of gas turbine engines during original manufacture and during repair operations. Such heat straightening is commonly accomplished using the same weld process (e.g. gas tungsten arc welding) used to make the original weld. Unfortunately, such heat straightening is imprecise. Too much heat over-corrects and too little heat under-corrects the distortion. Welds in sheet metal or large plate fabrications can cause complex and difficult to predict distortions such as buckling or bulging in three dimensions. These are difficult to correct accurately by any known process.

Lasers offer a source of heat for metal forming and straightening. Some known mechanisms of laser bending of sheet metal include: a) Temperature Gradient Mechanism; b) Buckling; and c) Shortening. These mechanisms are known in the art and are publicly available, so they are not detailed herein. For example, see Section 2.0 of “Laser Assisted Forming for Ship Building” by G. Dearden and S. P. Edwardson, of the University of Liverpool, presented at the Shipyard Applications for Industrial Lasers Forum (SAIL), Williamsburg, Va., Jun. 2-4, 2003.

### BRIEF DESCRIPTION OF THE DRAWINGS

The invention is explained in the following description in view of the drawings that show:

FIG. 1 is a schematic view of an apparatus performing a method of the invention.

FIG. 2 is a top view of a workpiece with a laser heating zone defined by the periphery of a bulge to be flattened, showing two types of laser scan patterns.

FIG. 3 is a top view of a workpiece illustrating two more types of scan patterns.

FIG. 4 illustrates a concentric type of laser scan pattern.

FIG. 5 is a schematic view of a second embodiment of an apparatus performing a method of the invention.

FIG. 6 is a schematic view of a third embodiment of an apparatus performing a method of the invention on a gas turbine blade as viewed along line 6-6 of FIG. 7

FIG. 7 is a top view of a gas turbine blade with a dashed outline indicating distortion that would occur from thermal expansion of the pressure side without heat compensation on the suction side during additive processing as shown in FIG. 6.

### DETAILED DESCRIPTION OF THE INVENTION

The present inventors recognized that laser energy can be accurately scanned over one or more defined areas of a metal surface by rastering the beam with mirrors, for precision bending of an article to correct complex distortions thereof.

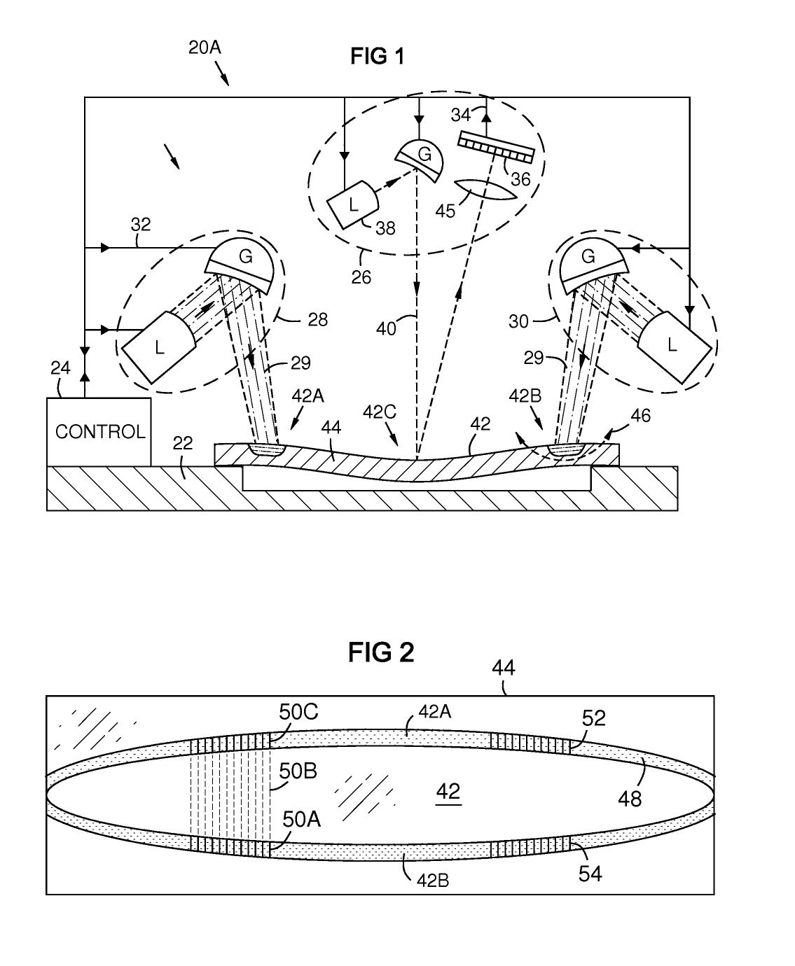

FIG. 1 shows an apparatus 20A performing a method of the invention. The apparatus includes a fixturing mechanism or work table 22, a controller 24, a surface imaging scanner 26, a controllable emitter 28 of an energy beam 29, and optionally, one or more additional controllable beam emitters 30. Control lines 32 are indicated by arrows directed toward peripherals L, G from the controller. “L” represents a laser emitter, and “G” represents a galvanometer actuated mirror. Alternately, other types of energy beams and actuators may be used. A sense line 34 is indicated by an arrow directed toward the controller from an image sensor 36. The imaging scanner 26 may comprise a triangulation laser scanner with a laser emitter 38 that produces a beam 40 scanned across a surface 42 of the workpiece 44 by an actuator such as a galvanometer G, and a camera comprising a lens 45 and a sensor 36 such as a charge coupled device (CCD). Such scanners can currently image a surface in 3 dimensions to a precision of at least 10s of microns or thousandths of an inch. The surface 42 has a central bulge with peripheral areas 42A, 42B that are curved in a first direction and a middle area 42C curved in an opposite direction.

The controller 24 may be a computer that stores a specification of the surface 42 provided by computer aided engineering software and digital storage media. The workpiece is fixed to the worktable 22 or other fixturing device. The scanner 26 images the surface and provides surface coordinates to the controller. The controller compares the actual surface shape to the specified shape, and determines corrections to be made. In this example, the workpiece has a bulge to be reversed to provide a planar workpiece. This can be done by heating a periphery of the bulge. Parameters of the heating laser(s) 29 determine the direction and degree of corrective bending. In FIG. 1, a temperature gradient mechanism is being employed to bend 46 the periphery of the bulge in a direction toward the laser to straighten the workpiece 44 by plasticizing or melting the near side while thermally expanding the far side of the workpiece.

When removing a bulge as in FIG. 1 it is beneficial to bend opposite sides of the bulge simultaneously to prevent resistance to the correction on one side by the distorted opposite side. To this end, two laser emitters 28, 30 may process respective opposite sides of the bulge periphery simultaneously. Alternately, time sharing of a single source emitter could be performed sufficiently rapidly to heat separate areas on the workpiece.

FIG. 2 shows a top view of a workpiece 44 with a laser heating zone 48 that has been identified by the controller 24 around the periphery of a bulge to flatten the bulge. This heating zone follows one or more sectionally curved surface areas 42A, 42B as seen in a sectional view as in FIG. 1. A first type of raster scan pattern (50A-C) forms tracks that are transverse to the bulge periphery. Heating portions 50A, 50C are on opposite sides of the laser heating zone 48. A spanning portion 50B of the tracks traverse the bulge with the laser turned off or with the laser beam speed of such large magnitude so as to deposit minimal energy over 50B. Alternately, the spanning portion 50B may apply a different laser power to the central portion of the bulge to soften it and/or bend it in the opposite direction from the periphery as later described. With this pattern heating can be performed on opposite sides of the bulge periphery effectively simultaneously with a single laser. Herein “effectively simultaneous heating” means heating that progresses concurrently in two separate areas 50A, 50C by accumulating heat therein over multiple passes, although the energy beam may not be in both areas at once. A second type of laser scan pattern 52, 54 is shown with separate scan patterns on opposite sides of the bulge periphery. These two patterns 52, 54 may be applied simultaneously with two lasers as shown in FIG. 1.

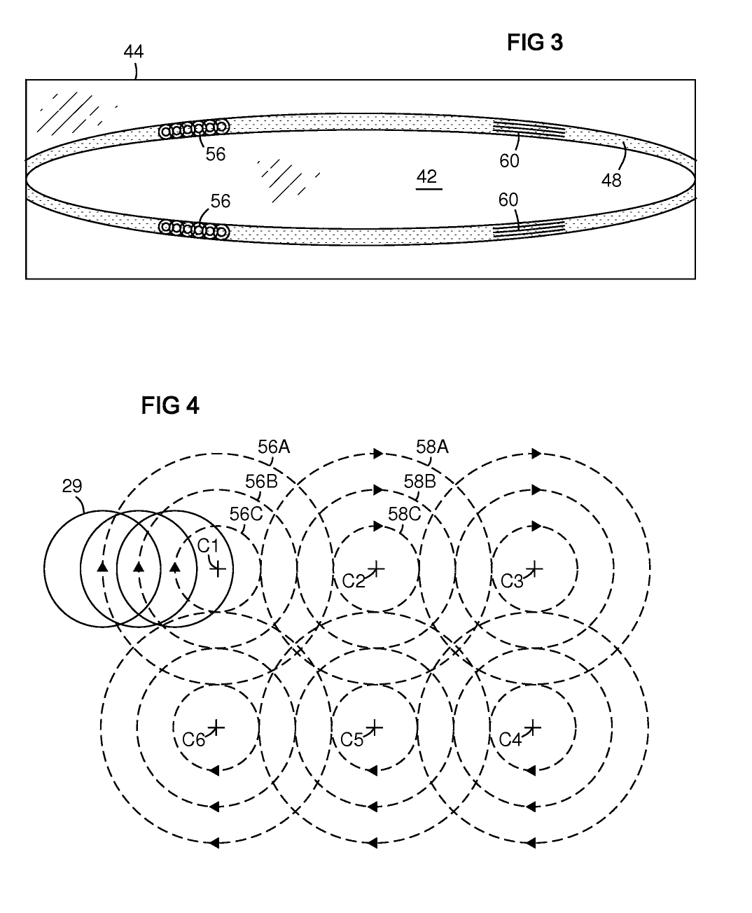

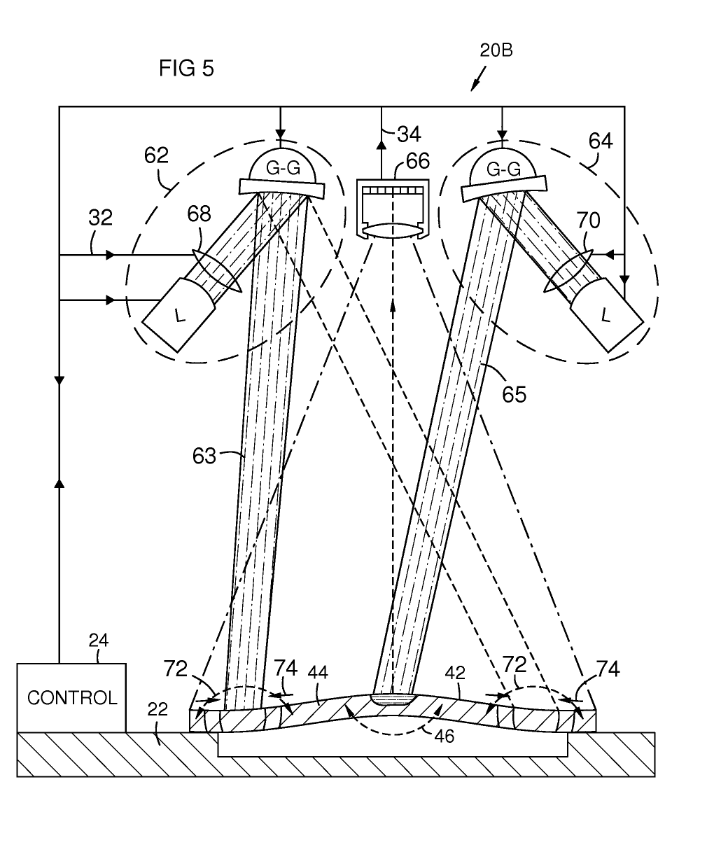

FIG. 3 is a top view of a workpiece 44 with a laser heating zone 48 that has been identified by the controller 24 around a periphery of a bulge to flatten a bulge. It shows a third type of laser scan pattern 56 with concentric heating tracks. A fourth type of laser scan pattern 60 has tracks parallel to the periphery of the heating zone 48. These scan patterns 56 and 60 are may be applied on opposite sides of the bulge periphery either effectively simultaneously or simultaneously using 1 or 2 lasers respectively. Pattern 60 may optionally be scanned continuously around the whole heating zone 48 using one or more lasers. Since laser beams maintain their intensity with distance from the emitter, the emitters can be located at an optimum distance from the workpiece for wide angle coverage thereof. The distance may be sufficient to enable the laser(s) to scan much or all of the heating zone 48 from one emitter position using 2-axis pivoting actuators as in FIG. 5. FIG. 4 shows a laser scan pattern in which the beam 29 follows a first set of concentric tracks 56A-C about a first center C1, then follows a second set of concentric tracks 58-C about a second center C2, and may continue to follow additional sets of concentric tracks about successive centers C3-C6. Each set of concentric tracks may contain at least 2 concentric tracks, or at least 3, and overlaps with an adjacent set or sets of concentric tracks. For example, the overlap may be about ⅓ of the diameter of the largest track of each set. This pattern provides controllable multi-pass dwell time in a limited area without hot spots on the surface, enabling implementation of a desired heating specification.

FIG. 5 shows a second embodiment of an apparatus 20B performing a method of the invention. The apparatus has a fixturing mechanism or work table 22, a controller 24, first and second 2-dimensional scanning laser emitters 62, 64, and a surface imaging camera 66. Control lines 32 are indicated by arrows directed toward emitters L, lenses 68, 70, and mirror actuators G-G from the controller. A sense line 34 is indicated by an arrow directed toward the controller from the camera 66. Each energy beam 63,65 may be scanned about two axes by a mirror driven by galvanometers G-G or other means. Alternately, a single pivoting mirror actuator may be provided, with the second dimension provided by a translation mechanism. The third dimension, focus depth, may be controlled by a lens 68, 70 to maintain a desired focus of the beam at the workpiece surface 42. A third laser emitter 38 as in FIG. 1 (not shown here) may be provided for the camera. Alternately, one or both of the main beams 63,65 may be controlled to provide surface image scanning at reduced power to reflect a spot image into the camera for surface analysis.

FIG. 5 further illustrates a method in which both bending and shrinkage are used to achieve dimensional specifications of the workpiece. A laser bending mechanism such as shortening (see Dearden and Edwardson, supra) may be used to bend the periphery in a direction 72 away from the laser and shorten it 74. A first laser 62 may scan a beam 63 to heat opposite sides of the bulge periphery or the whole periphery essentially simultaneously. A second laser 64 may scan a second beam 65 over a middle area of the bulge to soften and optionally bend it in a direction 46 toward the emitter with the previously mentioned temperature gradient method. However, if the middle of the bulge is only bent elastically by the distortion, and not plastically, then plastic reversal of the middle of the bulge is not needed. In that case, the two laser devices 62, 64 may respectively cover opposite sides of the bulge periphery simultaneously.

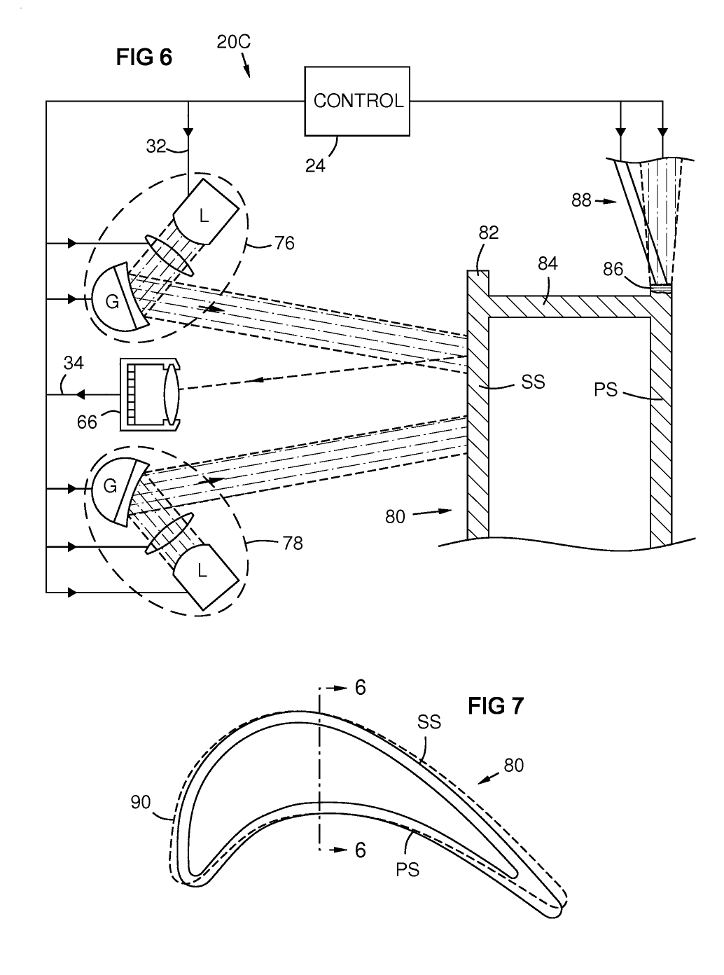

FIG. 6 shows a third embodiment 20C of an apparatus performing a method of the invention. The apparatus includes a controller 24, a surface-imaging camera 66, a controllable laser emitter 76, and optionally, one or more additional laser emitters 78. An additional image scanning laser emitter 38 as in FIG. 1 (not shown here), may be provided for the camera 66, or the main emitters 76, 78 may be controlled for surface imaging. This figure illustrates a method used during repair or fabrication of a component. A gas turbine blade 80 has a pressure side PS, a suction side SS, and a squealer ridge 82 extending above the periphery of a blade tip cap 84. The squealer ridge on the pressure side is in the process of additive fabrication 88 forming a melt pool 86 of additive superalloy. This process heats the pressure side of the blade tip, and thus distorts the tip by differential thermal expansion as shown by the dashed line 90 in FIG. 7. To prevent this, the apparatus of FIG. 6 detects the distortion early via the scanning camera 66 and/or determines the distortion predictively by mathematical modeling, and applies compensating heating to the suction side of the blade tip. This avoids introducing stress in the blade due to shape changes during processing and cooling of the squealer ridge. It also avoids heating the whole blade in an oven to prevent such distortion during processing and cooling, thus reducing energy and time.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
determining a deformation comprising a departure from a specified shape of a surface of a metal article;
directing a first energy beam to a first sectionally curved area of the determined deformation of the metal surface as seen in a sectional view thereof; and
controlling the first energy beam to correct the deformation by a compensating thermal effect in a thickness of the metal article that reduces a curvature of the first curved area.

2. The method of claim 1, further comprising directing the first energy beam to scan the first sectionally curved area in a series of sets of concentric tracks, each set overlapping an adjacent set.

3. The method of claim 1, wherein the deformation comprises an existing bulge in the surface, and further comprising directing the first energy beam to follow a series of raster scan tracks along and parallel to a periphery of the bulge.

4. The method of claim 3, wherein the series of raster scan tracks heats opposite sides of the periphery effectively simultaneously.

5. The method of claim 1, wherein the deformation comprises an existing bulge in the surface, and further comprising directing the first energy beam to scan opposite sides of a periphery of the bulge to plastically straighten the periphery and flatten the bulge.

6. The method of claim 1, wherein the deformation comprises an existing bulge in the surface, and further comprising directing the first energy beam to heat first and second sectionally curved areas on respective first and second opposite peripheral sides of the bulge essentially simultaneously to plastically straighten the first and second sectionally curved areas and flatten the bulge.

7. The method of claim 1, wherein the deformation comprises an existing bulge in the surface, and further comprising directing the first energy beam to heat a first portion of a periphery of the bulge while simultaneously directing a second energy beam to heat a second portion of the periphery of the bulge to plastically straighten the first and second portions of the periphery and flatten the bulge.

8. The method of claim 1, wherein the deformation comprises existing first and second oppositely sectionally curved areas of the metal surface as seen in a sectional view thereof, and further comprising directing a second energy beam to the second sectionally curved area simultaneously with directing the first energy beam to the first sectionally curved area, using first energy parameters for the first energy beam that bends the first sectionally curved area in a first direction, and using second energy parameters for the second energy beam that bends the second sectionally curved area in an opposite direction from the first direction, straightening the first and second sectionally curved areas.

9. The method of claim 8, wherein the first sectionally curved area comprises a peripheral portion of a bulge on the metal surface, and the second curved surface comprises a middle portion of the bulge.

10. The method of claim 1, further comprising determining the deformation on a first portion of the article by a surface-imaging camera during a repair or fabrication of the article in which additive welding is used on a second portion of the article, wherein the additive welding creates the deformation by differential thermal expansion during said repair or fabrication.

11. The method of claim 1, further comprising determining the deformation on a first portion of the article predictively for a repair or fabrication of the article in which additive welding is used on a second portion of the article, wherein the determined deformation is prevented by the compensating thermal effect of the first energy beam on the first portion of the article.

12. A method comprising:
obtaining an image a surface of a metal article;
determining from the image a deformation of the surface comprising a departure from a specified shape of the surface; and
rastering a first laser beam over a first area of the deformation to correct the deformation by a compensating thermal effect in a thickness of the article.

13. The method of claim 12, further comprising rastering the laser beam over a second area of the deformation to heat the first and second areas of deformation essentially simultaneously to plastically correct the first and second areas of deformation essentially simultaneously.

14. The method of claim 12, further comprising rastering a second laser beam over a second area of the deformation simultaneously with the rastering of the first laser beam over the first area of the deformation to plastically correct the first and second areas of deformation simultaneously.

15. A method comprising:
building a metal portion of article by additive fabrication on a first portion of the article; and
preventing a deformation of the article during the additive fabrication by scanning a laser beam over a second area of the article to compensate for differential thermal expansion of the article caused by the additive fabrication.
